(19) United States
(12) Patent Application Publication
(10) Pub. No.: US 2009/0219564 A1
(43) Pub. Date: Sep. 3, 2009

(54) METHOD OF IMPUTTING, ARCHIVING, CONSULTING, AND TRANSMITTING A DOCUMENT TO A RECIPIENT BY MEANS OF A CAMERA

(75) Inventors: Martin Lefebure, Courbevoie (FR); Antoine Martin, Argenteuil (FR)

Correspondence Address: BROWDY AND NEIMARK, P.L.L.C.;624 NINTH STREET, NW, SUITE 300, WASHINGTON, DC, 20001-5303, US

(73) Assignee: REALEYES3Dè, Saint Cloud Cedex (FR)

(21) Appl. No.: 12/278,859

(22) PCT Filed: Feb. 5, 2007
(86) PCT No.: PCT/FR07/00225

§ 371 Date: Apr. 14, 2009

(30) Foreign Application Priority Data
Feb. 8, 2006 (FR) 0601173
Mar. 27, 2006 (FR) 0602900

(51) Int. Cl. G06F 3/12; H04N 5/225

(52) U.S. Cl. 358/1.15; 348/207.1

(57) ABSTRACT

The method according to the invention comprises the capture and storage of an image of a document with the aid of a camera possibly integrated into a communication terminal, with transfer of the image into the memory of the terminal, the transmission by the terminal, to a server, of the image associated with complementary information, the extraction, correction and possibly interpretation by the server of the document-related information contained in the image, the reconstruction of the document with the aid of the information extracted, corrected and possibly interpreted and the archiving of the document while taking account of the information contained in the reconstructed document.

This invention relates to a method for entering, archiving, consulting and transmitting a document to a recipient by means of a camera possibly integrated into a communication terminal, a server and a terminal.

The method according to the invention is particularly adapted to a communication terminal equipped with a camera, but is also suitable to a camera having a means of storage able to connect to a communication terminal.

This method in particular but not exclusively applies to the capturing of an image of a paper document or present on any other support or media (white or black board, “flipchart”, panel, screen) using a camera possibly integrated into a communication terminal, to the transmission of the image to a server, then to the extraction, correction, interpretation and archival by the server of the data contained in the image, and finally to the searching and consulting of the data archived on the server, and the transmission thereof to a recipient or the sharing thereof on a local or non local communication network.

When it is desired to digitize a document in order to archive it or transmit it to a recipient by fax or email, a piece of equipment dedicated to document digitizing must generally be used such as a scanner, a photocopier or a fax. In addition, one must generally simultaneously have a terminal connected to the acquisition device in order to store the scan and possibly transmit it by email. This requires having these two pieces of equipment available at the time of the digitizing, which is generally not the case when travelling away from the office. In addition, if one has only a piece of equipment making it possible to digitize documents, one is often limited by its memory, and there is a risk of losing documents when the latter is full or defective. When a photocopier is used that is made available when out of the office, the device has the risk of not operating due to a lack of ink or paper, and the photocopies are not simultaneously made available to other interested and remote people.

Moreover, a wired or wireless connection with a network is necessary in order to transmit the document to a recipient by fax, email or by Internet. As such, when a document is transmitted to a recipient from a fax made available when travelling, the equipment is immobilised for an undetermined length of time and thus until the fax prints the receipt notification.

Moreover, it is common to desire to use document images captured using a camera having a fixed or mobile means of storage, then transmitted to a terminal by connecting it to the abovementioned fixed or mobile means of storage of the camera. If the terminal has image retouching software, it can then be sought to improve the readability of the text and graphic information relative to the document by improving the white balance, by adjusting the brightness, by enhancing the contrast, by accentuating the contrast, by improving the saturation, by attenuating the noise, by reframing the picture of the document, by flipping or reversing the image, by correcting the perspective, the chromatic aberration, the optical distortion, the unsharpness or the vignetting. These tedious operations of image retouching require sustained attention and much expertise in the field of graphics, but do not guarantee the obtaining of a result that is close to that of document digitizing using a scanner. Furthermore, it can be sought to interpret the information contained in the image with optical character or graphics recognition software in order to reuse it, which facilitates the search for the information, and reduces the size of the digitized information.

Finally, when it is desired to transmit a document in order to share it or publish it on a local network such as an intranet, or on a non local network such as an Internet site, a “weblog” or a file or image sharing site, and when one does not have a scanner, a picture of the document can be taken using a camera and can be transmitted to the sharing or publishing network using a communication terminal. However the text and/or graphic information shared or published in this way is often difficult to read due in particular to defects in the image of the document, linked to the lack of contrast or to an incorrect setting of the white balance.

The purpose of this invention in particular is to overcome these disadvantages and to make it possible to reconstitute a document using an image of the latter, then its archival, consultation and transmission to a recipient.

In this case, the method according to the invention can make use of:
A communication terminal TC;
A camera C having a fixed or mobile means of storage that can be connected to the communication terminal or, more preferably, the camera being connected and integrated to the communication terminal;
A server S equipped with a central unit grouping together means of treatment, memorisation and transmission;
A terminal T equipped with a central unit grouping together means of treatment, memorisation and transmission, a keyboard and a display device;
A recipient DES having a means of receiving, such as a terminal having means of receiving email, a fax, a server or a terminal connected to a local network such as an intranet or non local network such as Internet.

As such, the method according to the invention comprises the following steps:
Capturing and storing an image of the document using the camera C;
In the case where the camera is not connected to the communication terminal, connecting to the communication terminal of the fixed or mobile memory of the camera, and transferring the image into the memory of the communication terminal;
Transmitting by the communication terminal TC to the server S the image of the document, as well as possibly its recipient DES and/or its title and/or a comment;
Extracting, the correction and possibly interpreting, by means of treatment integrated into the server S, of the information relative to the document contained in the image, then reconstituting it by means of the extracted, corrected and possibly interpreted information;
Archiving the document on the server S taking into account the information contained in the reconstituted document as well as that concerning its history;
Optionally searching and/or consulting and/or modifying and/or suppressing and/or ordering for transmission to a recipient, the information relative to a document archived on the server S from the terminal T and/or the communication terminal TC;
Optionally transmitting by the server S to the recipient DES and/or to the communication terminal TC and/or terminal T, information relative to the reconstituted document and/or its history.

Advantageously, in the case where the server S receives the image of the document transmitted by the communication terminal TC, the server S can transmit a receipt notification message of the image to the communication terminal TC.

Advantageously, the extraction and the correction of the text and/or graphic information of the image of the document can be carried out using methods to extract raw data from a photographic image already proposed by the Applicant in application PCT/FR05/00678, and comprising the following steps:
the determination, for each pixel marked by the column C and the line L of the image, of a value V₀ [C, L] consisting in a combination of image colour components
the calculation, for each pixel, of a background value V_{Fond} (C, L)
the calculation, for each pixel, of the difference D [C, L]
D [C, L]=V_{Fond}-V₀ [C, L] (dark data/light background)
or
V₀ [C, L]-V_{Fond} (light data/dark background)
the calculation of a threshold value Vs consisting of a context data of noise used to correct the extracted raw data D [C, L], using at least one bar graph of the contrast and/or of the probability q that a regional maximum of raw data contains noise
the correction of the raw data D [C, L] using the context data of noise Vs resulting in the extracted data D*[C, L]
the calculation, for each pixel, of a corrected value I*[C, L] taking the corrected raw data D*[C, L] into account
the possible presentation of the extracted data or of the image containing it at a desired angle.

The same method is characterised in that, in the case of the presentation of data extracted from an image or of an image containing it according to the desired angle of view, using an image taken by a camera at any incidence, it comprises:
the search for at least four identifiable characteristic pixels of a pattern present in the image taken by the camera defining contextual data, with these characteristic pixels able to consist of the corners of the image,
the possible extraction of data according to predetermined criteria,
the calculation of the geometric distortions to be made to the raw image or to the extracted data or to the image containing it, using the relative position of the four pixels, in relation to reference relative positions,
the determination of the corrections to be made to the raw image or to the extracted data or to the image containing it, according to the geometric distortions,
the generation of a corrected image that takes the corrections determined as such into account.

The same method is also characterised in that, with the purpose of obtaining a corrected image presenting the same proportions as the object, it comprises the determination of the actual height/width ratio of the quadrilateral defined by the abovementioned pixels and the taking into account of this ratio r in the generation of the corrected image.

As such, the correction of the extracted text and/or graphic information can involve the geometry, the colour, the unsharpness and/or the contrast and, in a non exhaustive way, the improvement of the white balance, the adjustment of the brightness and of the contrast, the enhancement of the contrast, the accentuation of the contrast, the improvement of the saturation, the attenuation of the bruit, the reframing of the picture of the document, the flipping or the reversing of the image, the correction of the perspective, of the chromatic aberration, of the optical distortion, of the unsharpness or of the vignetting.

Advantageously, the archival by the server S of the document will comprise the following steps:
the generation of a reduced image of the reconstituted document;
the generation of index tables that take the information relative to the document to be archived into account.

Advantageously, the information relative to a document contained in the reconstituted document as well as that concerning its history can involve:
the filename of the image of the document;
the possible title and/or comment transmitted by the communication terminal or the terminal T;
the location and/or the date and/or the time of the capture of the image of the document;
the date of transmission of the image of the document to the server;
the status of the reconstitution of the document;
the date of reconstitution of the document;
the recipients, dates and statuses of the transmissions of the document to these recipients;
the text information possibly interpreted using optical character recognition software;
the graphic information possibly interpreted using shape recognition software.

Advantageously, the result of the possible search for information relative to a document from the terminal T or the communication terminal TC can include the list of documents of which the relative information is that which is searched, possibly accompanied with certain pieces of their relative information.

Advantageously, in the event where the quality or the resolution of the image of the document does not make it possible to extract text or graphic information that is readable or that can be interpreted by optical character or shape recognition software, even after correction, the server S can transmit a warning message to the terminal T or to the communication terminal TC, possibly along with recommendations making it possible to improve the picture taking of the document.

In the opposite case where the text and graphic information extracted from the image of the document, then corrected, are deemed as readable or able to be interpreted by optical character or shape recognition software, the server S can transmit a warning message to the communication terminal TC or to the terminal T.

Advantageously, in the event the server S has received a receipt notification of the transmission by fax or email of the digitized document to the recipient DES, the server S can transmit a receipt notification message to the communication terminal TC or to the terminal T.

Advantageously, the transfer of the image or of the information relative to the document shall take place by the intermediary of a wired connection such as the Serial or USB link, or wireless connection such as 802.11, Wimax or Bluetooth, or by a wired and switched communication network, ADSL, or a cellular network such as GSM, GPRS or UMTS, or a local network such as an intranet, or a non local network such as Internet.

1. Method for entering, archiving, consulting and transmitting to a recipient a document by means of a camera, a communication terminal, a server (S) and a terminal (T), said method comprising the following steps:
capturing and storing an image of the document using the camera;
in the case where the camera is not connected to the communication terminal, connecting the fixed or mobile memory of the camera to the communication terminal, and transferring the image into the memory of the communication terminal;
transmitting by the communication terminal to the server the image of the document, as well as data relative to the recipient, its title and a comment;
extracting, correcting and interpreting, by means of treatment integrated into the server, information relative to the document contained in the image, then reconstituting a document using the extracted, corrected and interpreted information;
archiving the reconstituted document on the server taking into account the information contained in the reconstituted document as well as that concerning its history;
searching and consulting the information relative to a document archived on the server from the terminal or the communication terminal.

2. Method according to claim 1, wherein the camera is integrated into the communication terminal.

3. Method according to claim 1, wherein the step of searching or of consulting is followed by a step of modification of the information relative to a document archived on the server.

4. Method according to claim 1, wherein the step of searching or of consulting is followed by a step of ordering the transmission to a recipient.

5. Method according to claim 4, further comprising the transmission by the server to the recipient, to the communication terminal or to the terminal, of information relative to the reconstituted document.

6. Method according to claim 1, wherein, in the case where the server receives the image of the document transmitted by the communication terminal, the server transmits a receipt notification message of the image of the document to the communication terminal.

7. Method according to claim 1, wherein the correction of the information extracted from the image concerns parameters such as the geometry, colour, unsharpness, contrast, improvement in the white balance, adjustment of the brightness and of the contrast, enhancement of contrast, accentuation of the contrast, improvement in the saturation, attenuation of the noise, the reframing of the picture of the document, flipping, reversing of the image, correction of the perspective, of the chromatic aberration, of the optical distortion, of unsharpness or of the vignetting.

8. Method according to claim 1, wherein the archival by the server of the document comprises the following steps:
the generation of a reduced image of the reconstituted document;
the generation of index tables that take the information relative to the document to be archived into account.

9. Method according to claim 1, wherein the result of the possible search for information relative to a document comprises the list of the documents of which the relative information is that that is searched, possible accompanied with certain pieces of their relative information.

10. Method according to claim 1, wherein the information relative to a document contained in the reconstituted document as well as that concerning its history concerns the filename of the image of the document, the titles and/or a comment possibly transmitted by the communication terminal or the terminal to the server, the location and/or the date and/or the time of capture of the image of the document by the camera, the brand and/or the model of the camera, the date of transmission by the communication terminal of the image to the server, the status of the reconstitution of document, the date of reconstitution of the document, the successive recipients of the document, the dates and the statuses of the transmissions of the document to these recipients by the server, the text information possibly interpreted using optical character recognition software, the graphic information possibly interpreted using shape recognition software.

11. Method according to claim 1, wherein, in the event the quality or the resolution of the image of the document does not make it possible to extract text or graphic information that is readable or that can be interpreted by optical character or shape recognition software, even after correction, the server transmits a warning message to the terminal or to the communication terminal, possibly along with recommendations making it possible to improve the picture taking of the document.

12. Method according to claim 1, wherein, in the case where the text and graphic information extracted from the image of the document, then corrected, are deemed as readable or able to be interpreted by optical character or shape recognition software, the server transmits a warning message to the communication terminal and/or to the terminal.

13. Method according to claim 1, wherein, in the event the server has received a receipt notification of the transmission by fax or email of the digitized document to the recipient, the server transmits a receipt notification message to the communication terminal or to the terminal.
